(19) United States
(12) Patent Application Publication
(10) Pub. No.: US 2011/0269103 A1
(43) Pub. Date: Nov. 3, 2011

(54) EXPANDABLE IMPLANT

(75) Inventor: Daniel Andrew Shimko, Germantown, TN (US)

(73) Assignee: WARSAW ORTHOPEDIC, INC., Warsaw, IN (US)

(21) Appl. No.: 12/770,851

(22) Filed: Apr. 30, 2010

(51) Int. Cl. A61C 8/00

(52) U.S. Cl. 433/173

(57) ABSTRACT

An implant includes a body having a longitudinal axis, at least one expandable portion configured to move between an unexpanded configuration and an expanded configuration, and at least one linearly and non-rotatably movable expander member configured to contact the at least one expandable portions such that linear movement of the expander member moves the expandable portion between the unexpanded configuration and the expanded configuration.

### TECHNICAL FIELD

The present invention relates to implants which are surgically placed in bone to provide an anchoring means for a prosthesis or other device. In particular, the implant of the present invention is especially advantageous for use in dental surgery.

### BACKGROUND

Implants are widely used in dental surgery for restoration of the jaw anatomy. Implants can be used, for example, for anchoring a dental prosthesis such as an artificial tooth to the jawbone of a patient. Various types of dental implants are disclosed, for example, in U.S. Pat. Nos. 7,179,088, 6,991,461, 6,863,530, 6,227,860, 5,951,288, 5,931,674, 5,863,200, 5,470,230, 5,417,569, and 4,531,916, all of the above references being incorporated by reference herein.

A typical dental implant has a generally cylindrical shaped body which is mounted into a hole pre-drilled in the jawbone. The implant can be threadedly fitted or press fitted into the hole. The prosthesis can then be fixedly mounted to the implant secured within the bone. However, it is possible for the implant to loosen if, for example, the hole is or becomes too big or is improperly drilled. This can result in loss of the implant or prosthesis and require a subsequent operation to remedy the situation. The present disclosure describes a dental implant which can be radially outwardly expanded within the pre-drilled hole in the jawbone to secure the dental implant with a tight friction fit to the bone structure.

### SUMMARY OF THE INVENTION

Accordingly, an implant and method are provided herein for anchoring a prosthesis, such as an artificial tooth to the jawbone. In one embodiment the implant comprises a body having a longitudinal axis, at least one expandable portion configured to move between an unexpanded configuration and an expanded configuration; and at least one linearly and non-rotatably movable expander member configured to contact said at least one expandable portion such that linear movement of said at least one expander member moves the at least one expandable portion between the unexpanded configuration and the expanded configuration.

In one embodiment of the present invention, the implant comprises a generally cylindrical body defining a linear axis and having upper and lower expandable portions. The expandable portions are movable between an unexpanded configuration and an expanded configuration in response to linear movement of upper and lower expander members. The upper and lower expander members are each linearly movable between a first position in which the upper and lower expansion portions are in the unexpanded configuration and a second position in which the upper and lower expansion members are in the expanded configuration.

In an embodiment of the present invention, the dental implant further comprises a rotatable rod axially extending through the dental implant and threadedly connected to the upper and lower expansion members such that the linear movement of the expander members is responsive to rotation of the rod.

In an embodiment of the present invention, the upper and lower expansion portions of the dental implant each include a plurality of longitudinal slots.

In an embodiment of the present invention, each of the upper and lower expander members of the implant includes a peripheral beveled surface.

In an embodiment of the present invention, each of the upper and lower expander members of the dental implant includes a plurality of longitudinal ridges, each longitudinal ridge being slidably disposed within a respective longitudinal slot of the upper and lower expansion portions of the body.

In an embodiment of the present invention, the peripheral beveled surface of the upper expander member of the implant is in camming contact with an upper circumferential edge and/or an interior surface of the upper expansion portion and the peripheral beveled surface of the lower expander member is in camming contact with a lower circumferential edge and/or interior surface of the lower expansion portion.

In one embodiment of the present invention, the implant includes means for locking the implant body in the fully expanded configuration.

In an embodiment of the present invention, the cylindrical body of the implant includes gripping means disposed on an exterior surface of the cylindrical body for increasing frictional contact with bone into which the implant is positioned.

In an embodiment of the present invention, the gripping means of the dental implant includes at least one circumferentially extending ridge having a horizontal radially extending upper surface and an angled lower surface.

In one embodiment of the present invention, the gripping means of the dental implant includes at least one circumferentially extending ridge having a horizontal radially extending upper surface and a horizontal radially extending lower surface.

In an embodiment of the present invention, the gripping means of the dental implant includes at least one circumferentially extending ridge having an angled upper surface and an angled lower surface.

In an embodiment of the present invention, the gripping means of the dental implant comprises a textured surface.

In an embodiment of the present invention, the gripping means of the implant comprises at least one radially outward extending conical spike.

In an embodiment of the present invention, the gripping means of the implant comprises at least one radially outward extending block having a perimeter which is polygonal, circular or oval. The block can further include an outward facing textured surface.

In one embodiment of the present invention, the gripping means of the implant includes at least one pyramidal projection.

In an embodiment of the present invention, the cylindrical body of the implant includes a radially inward projecting portion having a circular groove, and the rod includes a disk rotatably disposed within said circular groove.

In an embodiment of the present invention, the cylindrical body of the implant is fabricated from a bio-compatible metal, synthetic polymer, ceramic or bone.

In one embodiment of the present invention, the implant body includes openings to permit the ingrowth of bone tissue.

In an embodiment of the present invention, a method for implanting a prosthesis is provided. The method includes providing an implant including a body having a longitudinal axis, at least one expandable portion configured to move between an unexpanded configuration and an expanded configuration; and at least one linearly and non-rotatably movable expander member configured to contact said at least one expandable portions such that linear movement of said at least one expander member moves the at least one expandable portion between the unexpanded configuration and the expanded configuration; drilling a hole in a bone, such as a jawbone; inserting the implant into the hole in the hole while the implant is in the unexpanded configuration; moving the implant into the expanded configuration; and connecting a prosthesis to the implant, such as a dental prosthesis.

In one embodiment of the present invention, the method comprises rotating the rod to move the upper expander member lower and the lower expander member upward thereby moving the upper and lower expansion portions radially outward.

### BRIEF DESCRIPTION OF THE DRAWINGS

Various embodiments of the invention are described below with reference to the drawings, wherein:

FIG. 1 is a sectional elevational view of an embodiment of the invention;

FIG. 2 is a perspective view of an embodiment of the invention;

FIG. 3 is a partially cut-away view of the invention implanted in bone;

FIGS. 4A to 4G illustrate embodiments of gripping projections;

FIG. 5 is a sectional view of an alternative embodiment of the invention;

FIG. 6 is a sectional elevational view of another alternative embodiment of the invention;

FIG. 7 is a partially sectional elevational view of yet another alternative embodiment of the invention; and

FIG. 8A and 8B illustrate means for attachment of a prosthesis.

### DETAILED DESCRIPTION

The present invention may be understood more readily by reference to the following detailed description of the invention taken in connection with the accompanying drawing figures, which form a part of this disclosure and in which like numbers indicate like features. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value.

When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”. As used herein, “comprising”, containing”, “characterized by” and grammatical equivalents thereof are inclusive or open-ended terms that do not exclude additional, unrecited elements or method steps, but will also be understood to include the more restrictive terms “consisting of” and “consisting essentially of.”

The following discussion includes a description of an implant system, related components and exemplary methods of employing the implant system in accordance with the principles of the present disclosure. More particularly, the exemplary embodiments of the implant are particularly suitable for use in dental surgery and provide a stable anchoring for a dental prosthesis such as an artificial tooth. Additional embodiments are also disclosed. It should be noted that although the implant of the invention is described with reference to dental surgery, it can also be used in any type of surgery in which a prosthesis is to be attached to bone. Accordingly, the scope of the present invention is not limited to only dental implants. Reference will now be made in detail to the exemplary embodiments of the present disclosure, which are illustrated in the accompanying figures.

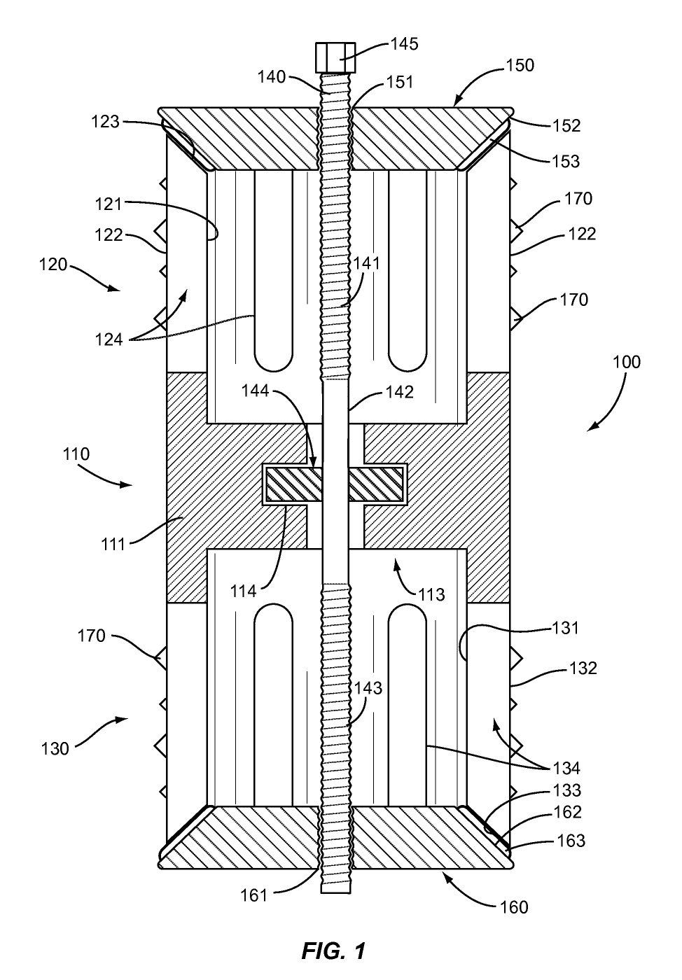

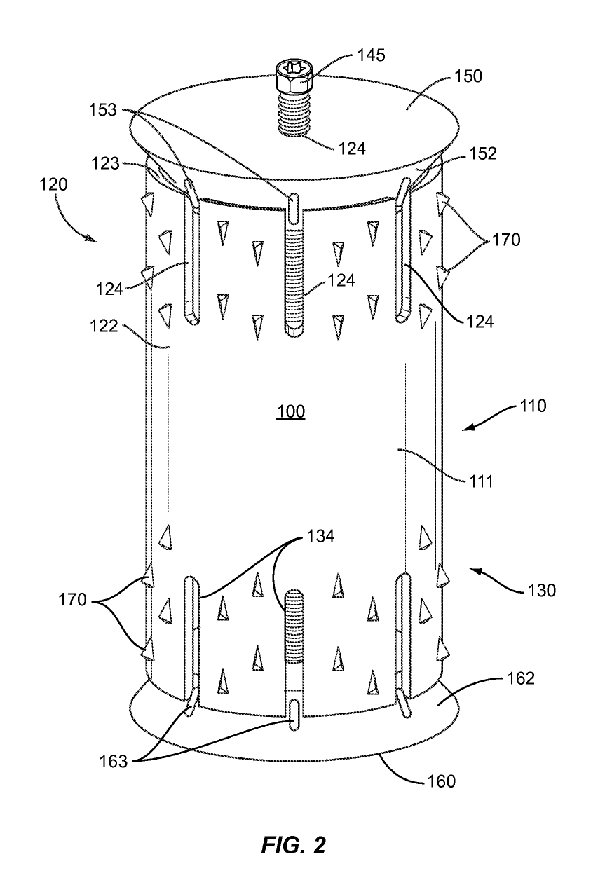

Referring now to FIGS. 1 and 2, in an exemplary embodiment the implant 100 includes a generally cylindrical body 110 having an expandable upper portion 120, a central portion 111, and an expandable lower portion 130. The implant 100 further includes an upper expander member 150, a lower expander member 160, and an axially extending threaded rod 140.

The components of the implant system are fabricated from materials suitable for medical applications, including metals, synthetic polymers, ceramics, bone, bio-compatible materials and/or their composites, depending on the particular application and/or preference of a medical practitioner. For example, components of the implant system, such as, for example, an implant body, an outer surface of the implant body and/or portions thereof, cavities of the implant body, which may be monolithically formed, integrally connected or configured as an insert with the body, fastening elements and/or instruments and/or expanding devices, discussed below, can be fabricated from materials such as commercially pure titanium, titanium alloys, Grade 5 titanium, super-elastic titanium alloys, cobalt-chrome alloys, stainless steel alloys, superelastic metallic alloys (e.g. Nitinol, super elasto-plastic metals, such as GUM METAL® manufactured by Toyota Material Incorporated of Japan), thermoplastics such as polyaryletherketone (PAEK) including polyetheretherketone (PEEK), polyetherketoneketone (PEKK) and polyetherketone (PEK), carbon fiber reinforced PEEK composites, PEEK-BaSO₄ composites, ceramics and composites thereof such as calcium phosphate (e.g. SKELITE™), rigid polymers including polyphenylene, polyamide, polyimide, polyetherimide, polyethylene, polyurethanes of any durometer, epoxy and/or silicone. Different components of the implant system may have alternative material composites to achieve various desired characteristics such as strength, rigidity, elasticity, compliance, biomechanical performance, durability and radiolucency or imaging preference. The components of the implant system may also be fabricated from a heterogeneous material such as a combination of two or more of the above-described materials.

It is envisioned that the components of the implant system can be manufactured via various methods. For example, the implant body can be manufactured and assembled via injection-molding, insert-molding, overmolding, compression molding, transfer molding, co-extrusion, pultrusion, dip-coating, spray-coating, powder-coating, porous-coating, milling from a solid stock material, and their combinations. One skilled in the art, however, will realize that such materials and fabrication methods suitable for assembly and manufacture, in accordance with the present disclosure, would be appropriate.

More particularly, the cylindrical body 110 is preferably of single piece construction, although it may alternatively be fabricated in two or more parts which are subsequently assembled and permanently joined. In an embodiment, the body 110 includes an upper portion 120 including an inner surface 121, an outer surface 122, an upper edge 123, and upper longitudinal expansion slots 124. Upper edge 123 is optionally beveled at an angle to correspond to the beveled circumferential edge 152 of the upper expander member 150 as described more fully below.

Body 110 further includes a lower portion 130 including an inner surface 131, an outer surface 132, a lower edge 133, and lower longitudinal expansion slots 134. Lower edge 133 is optionally beveled at an angle to correspond to the beveled circumferential edge 162 of the lower expander member 160 as described more fully below.

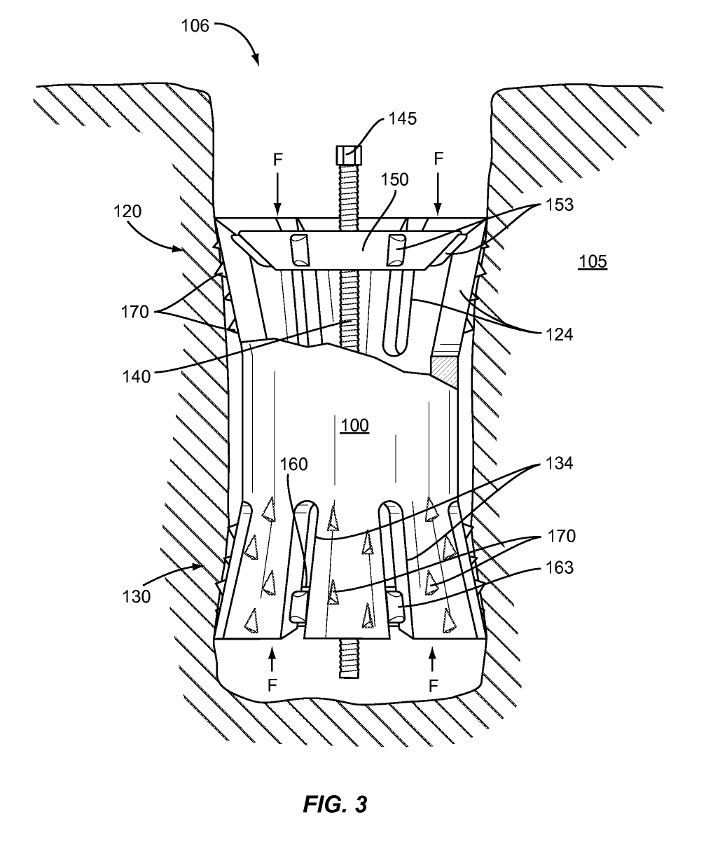

The upper portion 120 and lower portion 130 are adapted to expand radially outward in response to the linear movement of the respective upper and lower expander members 150 and 160. As explained below, linear movement of the expander members toward the longitudinal center of the implant 100 causes the circumferential edges 152 and 153 to cam against the respective inner surfaces 121 and 131 of the upper and lower portions 120 and 130, thereby causing the upper and lower portions 120 and 130 to bend in the vicinity of the central portion 111 and flare outwardly as shown in FIG. 3.

The outer surfaces 122 and 132 of upper portion 120 and lower portion 130, respectively, may include a plurality of gripping means 170 for frictionally engaging the inner surface of a hole pre-drilled into bone, as shown in FIG. 3 and explained more fully below.

Upper expander member 150 is a generally cylindrical disc shaped body having a threaded axial hole 151 and a beveled peripheral surface 152 defining a peripheral edge thereof. The angle of the beveled peripheral surface 152 preferably corresponds to the angle of the beveled upper edge 123 and can preferably range from 5 degrees to about 45 degrees off the longitudinal extension of the cylindrical body 110. Upper expander member 150 also includes a plurality of ridges 153 adapted to engage corresponding longitudinal expansion slots 124 of the upper portion 120 to prevent rotation of the upper expander member 150.

Lower expander member 160 is a generally cylindrical disc shaped body having a threaded axial hole 161 and a beveled peripheral surface 162 defining a peripheral edge thereof. The angle of the beveled peripheral surface 162 preferably corresponds to the angle of the beveled lower edge 133 and can preferably range from 5 degrees to about 45 degrees off the longitudinal extension of the cylindrical body 110. Lower expander member 160 also includes a plurality of ridges 163 adapted to engage corresponding longitudinal expansion slots 134 of the lower portion 130 to prevent rotation of the expander 160.

Rotatable rod 140 extends axially through the implant 100 and has an upper threaded portion 141, a middle portion 142, and a lower threaded portion 143. The upper threaded portion 141 is disposed through the axial threaded hole 151 in the upper expansion member 150. The lower threaded portion 143 is disposed through the axial threaded hole 161 in the lower expansion member 160. The threads of upper portion 141 have a reverse pitch from the threads of lower portion 143 such that, when the rod 140 is turned, the upper expander member 150 and the lower expander member 160 do not move in the same direction. That is, when the rod 140 is rotated, the upper expander member 150 is moved linearly downward without rotation toward the longitudinal center of the implant 100 whereas the lower expander member 160 moves linearly upward without rotation toward the longitudinal center of the implant 100. The upper end 145 of the rod 140 includes means for engagement with a wrench or other such tool for rotating the rod 140. Such means for engaging a tool can comprise, for example, a hexagonal surface or recess, a slot, multiple slots or openings, such as a Phillips head configuration or a “spanner” head configuration, a square surface or recess, or any other polygonal configuration, such as a Torx configuration, tri-wing configuration, or any other suitable means.

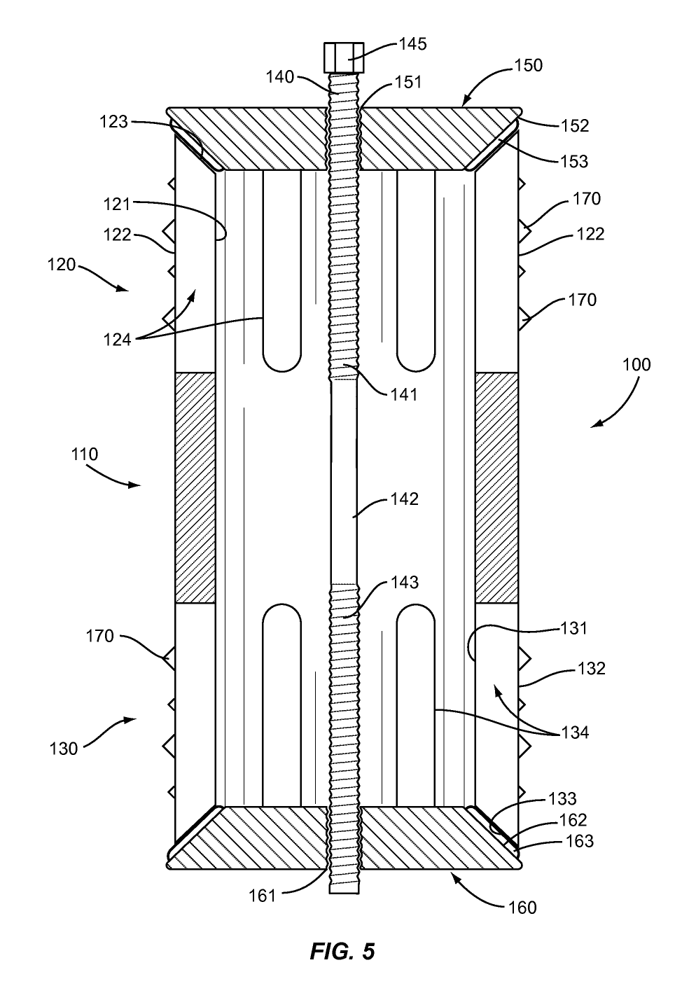

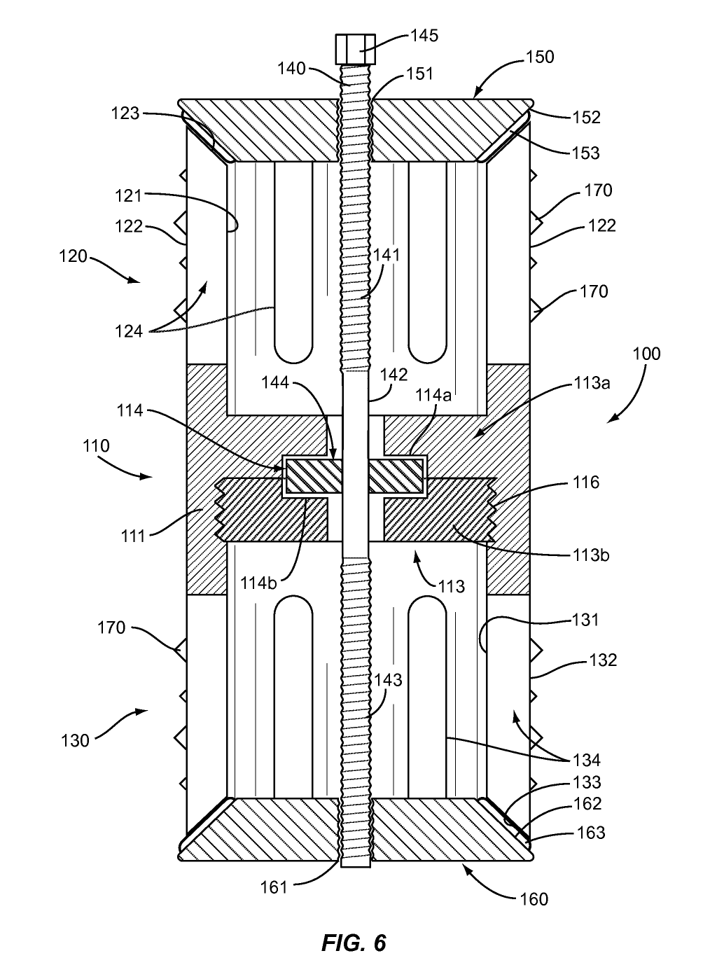

In one embodiment of the present invention, the central portion 111 of body 110 includes a radially inward projecting portion 113 having a circular groove 114. A disk 144 is fixedly mounted to the central portion 142 of rod 140 and is disposed within groove 114 so as to be freely rotatable therein. The arrangement of the disk 144 in groove 114 facilitates stabilization of the rod 140 to inhibit flexing in the middle thereof as well as any motion other than rotary motion. However, this arrangement is optional. As can be seen in FIG. 5, the dental implant can be fabricated without the disk 144, or inward projecting portion 113. An additional embodiment, shown in FIG. 6 and described below, illustrates a method of constructing the projecting portion 113.

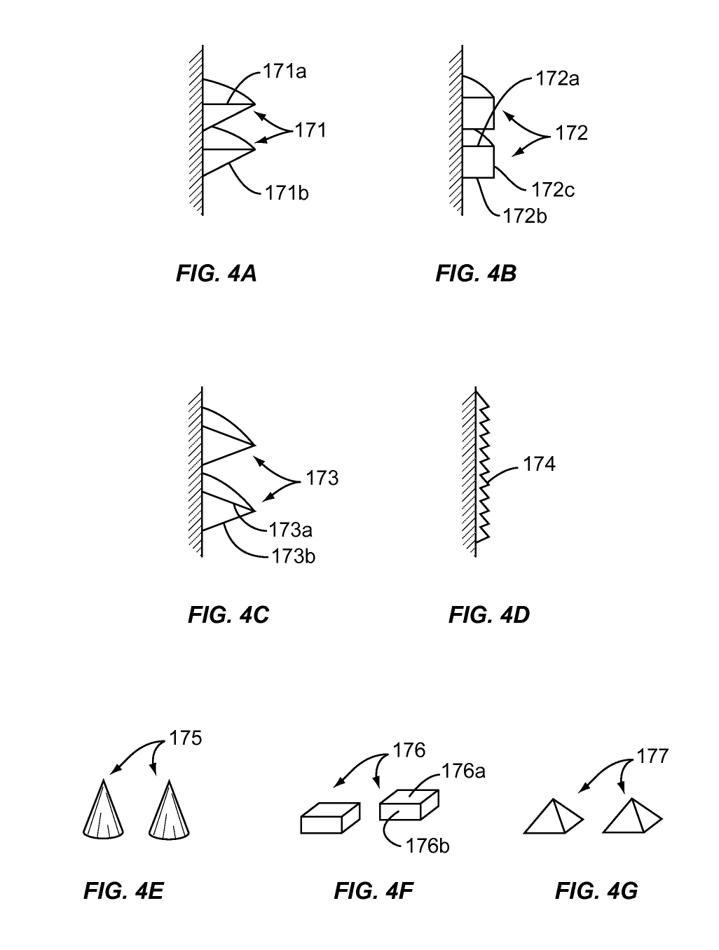

The gripping means 170 can be in any of a variety of exemplary forms as shown in FIGS. 4A to 4G. Such forms as shown in FIGS. 4A to 4G are given by way of example, and other forms suitable for the purposes described herein can alternatively be employed. Typically, the gripping means will include a plurality of gripping projections or surfaces disposed on the outer surfaces 122 and/or 132 of the body 110.

FIG. 4A illustrates gripping projections 171 which each comprise a circumferential ridge disposed along the outer surfaces 122 and/or 132 of the upper and lower portions 120, 130. The upper surface 171a of gripping projection 171 is horizontal and extends radially from the outer surface of the upper and/or lower portions 120, 130, whereas the lower surface 171b is angled. This configuration facilitates insertion of the implant 100 into a pre-drilled hole in the bone, but offers greater resistance to withdrawal of the implant from the hole.

FIG. 4B illustrates one embodiment of the gripping means 170. Gripping projections 172 each comprise a circumferential ridge disposed along the outer surfaces 122 and/or 132 of the upper and lower portions 120, 130. Both the upper surface 172a and the lower surface 172b are horizontal and extend radially outward from upper and/or lower portions 120, 130. Vertical surface 172c contacts the inner surface of the hole pre-drilled in the bone.

FIG. 4C illustrates an embodiment of the gripping means 170. Gripping projections 173 each comprise a circumferential ridge disposed along the outer surfaces 122 and/or 132 of the upper and lower portions 120, 130. Both the upper surface 173a and the lower surface 173b are angled from upper and/or lower portions 120, 130.

FIG. 4D illustrates an embodiment of the gripping means. Gripping surfaces 174 each comprise a textured, or rough surface to increase frictional contact with the inner surface of the hole pre-drilled in the bone.

FIG. 4E illustrates one embodiment of the gripping means 170. Gripping projections 175 each comprise a conical spike extending radially outward from the outer surfaces 122 and/or 132 of the upper and lower portions 120, 130.

FIG. 4F illustrates an embodiment of the gripping means 170. Gripping projections 176 each comprise a block extending radially outward from the outer surfaces 122 and/or 132 of the upper and lower portions 120, 130. As shown in FIG. 4F gripping projections 176 have a flat bone contacting surface 176a and a perimeter 176b comprising four sides so as to constitute quadrangular blocks. However, gripping projections 176 can alternatively can include a perimeter 176b having 3, 5, 6 or any other number of sides, or can alternatively have circular or oval perimeters. Moreover, the bone contacting surface 176a can be curved and can comprise a textured or rough surface to increase frictional contact with the bone.

FIG. 4G illustrates one embodiment of the gripping means 170. Gripping projections 177 each comprise a pyramid having at least three sides and extending radially outward from the outer surfaces 122 and/or 132 of the upper and lower portions 120, 130.

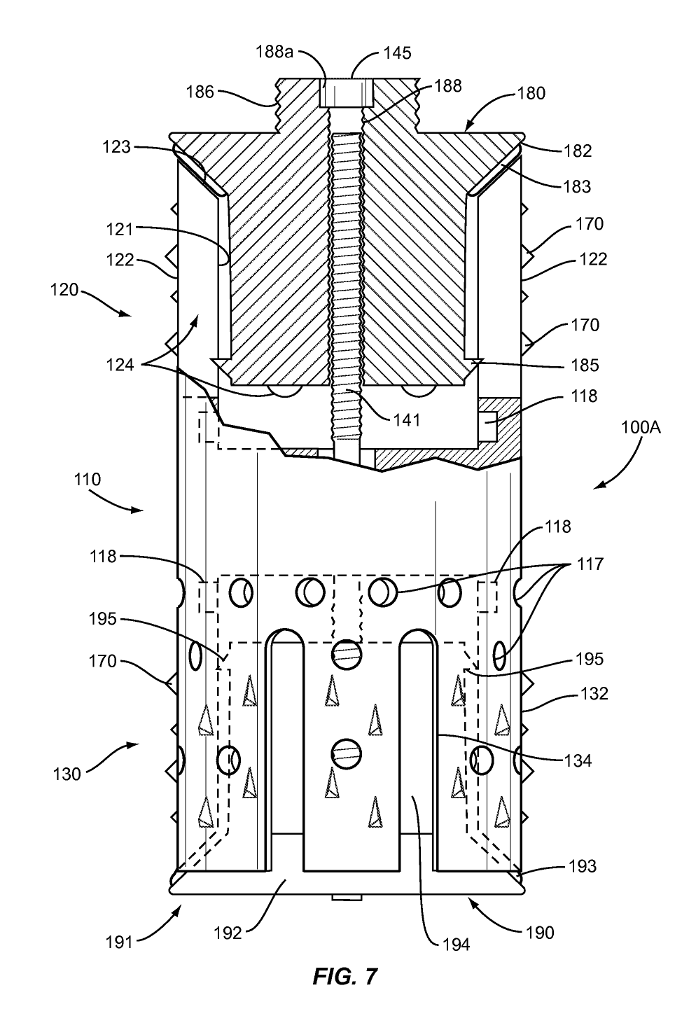

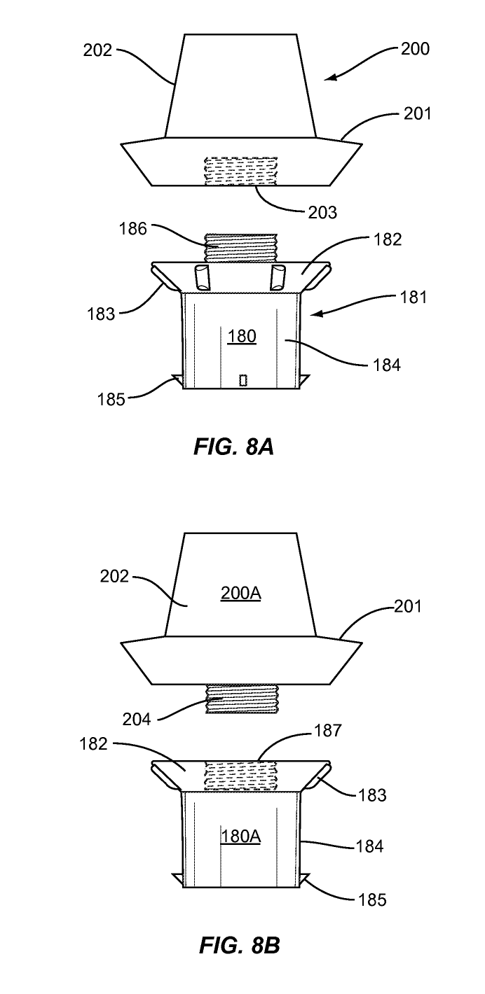

Referring now to FIG. 3, in a method for employing the implant 100, a hole 106 is first pre-drilled in bone 105 by any suitable method, the dimensions of the hole 106 being sufficient to receive the implant 100. The implant 100 is then inserted bottom-first into the hole when the implant is in the unexpanded configuration. After the implant 100 is properly seated, the rod 140 is rotated to apply a force F to move the upper expander member 150 linearly downward without rotation and the lower expander member linearly 160 upward without rotation. This, in turn, causes the upper and lower portions 120 and 130 to flex radially outward, thereby more tightly engaging the inner surface of the hole 106. Gripping means 170 further increase the frictional engagement with the bone to firmly secure the implant 100. Thereafter, the prosthesis (not shown), such as a dental prosthesis, can be attached to the implant, for example by engagement with the upper portion of rod 140. Exemplary means for engagement of the prosthesis with the upper portion of rod 140 are described below in connection with FIGS. 7 and 8.

In one embodiment of the present invention the upper and lower portions 120 and 130 expand sufficiently to grip the surrounding bone tissue and increase frictional contact with the sides of the hole 106 drilled in the bone 105. In another embodiment, the implant 100 can be adapted to apply sufficient radial force to expand the diameter of hole 106 by compressing the bone tissue 105. Bone tissue has some resiliency and the shape of the bone structure can be altered with sufficient compressive force. This increases the permanence and stability of the implant.

Referring now to FIG. 6 an embodiment is shown wherein the central projection 113 is constructed in parts. An initial portion 113a is integral with the body 110 and extends radially inward and includes a recess 114a which forms one part of slot 114. A separate cylindrical member 113b includes a threaded outer circumferential surface 116 adapted to engage corresponding threads on the inner surface of the body. Cylindrical member 113b includes a recess 114b to form another part of slot 114. To construct the implant, the central rod 140 is positioned in the implant with disk 144 mounted in recess 114a. Member 113b is then screwed into the implant 100 to retain disk 144 so that disk 144 is rotatingly movable within slot 114.

Referring now to FIGS. 7, 8A and 8B, an embodiment of the present invention is shown where the implant 100A includes upper expander member 180, and lower expander member 190. Upper expander member 180 includes a body 181 having a beveled circumferential surface 182 with ridges 183, and a lower cylindrical portion 184 having detents 185 adapted to resiliently engage corresponding recesses 118 (See, FIG. 7) on the interior surface of the implant body in a snap-in action. The upper expander member 180 further includes an axial threaded hole 188 through which threaded rod 140 is disposed. In an embodiment the upper portion 188a of the hole 188 has a cylindrical inner surface to permit rotation of the upper end 145 of the rod 140. In an embodiment shown in FIG. 8A, upper expander member 180 includes a threaded upper projection 186 to engage abutment member 200. Abutment member 200 serves as a base to which a prosthesis, such as a dental crown, can be adhesively or otherwise attached. The abutment member 200 includes an upper portion 202, and a lower portion 201 which includes a threaded recess 203 into which the threaded projection 186 can be engaged. The surface of the upper portion 202 and lower portion 201 can be coated with a durable cement and the dental prosthesis fixedly adhered thereto. Moreover, the threaded projection 186 can be coated with an adhesive to prevent loosening of the abutment member after it has been joined to the implant. Furthermore embodiment 100A (as well as the previously described implant embodiment 100) can include apertures 117 in the body 111 to permit the ingrowth of bone tissue, thereby facilitating the permanency of the implant fixation in the jawbone.

The lower expander member 190 includes a body 191 having a beveled circumferential surface 192 with ridges 193 and a cylindrical portion 194. In an embodiment cylindrical portion 194 includes detents 195 for engagement with corresponding recesses 118 in the interior surface of the implant body 111.

In an embodiment of the present invention shown in FIG. 8B, the upper expander member 180A can include a threaded recess 187 and the abutment member 200A can include a threaded projection 204 which engages the threaded recess 187 of the upper expander member 180. The threaded engagement between threaded projection 204 and recess 187 can be permanently secured by an adhesive to prevent subsequent loosening.

As with the previously described embodiments of the present invention, ridges 183 and 193 engage corresponding vertical expansion slots 124 and 134 to prevent rotation of the expander members. In operation, the implant 100 is inserted into a hole predrilled into bone. The threaded rod 140 is then engaged with an appropriate tool and rotated, which impels the upper expansion member 180 and lower expander member 190 to move to the middle of the implant body 111. This movement forces the upper portion 120 and lower portion 130 of the implant radially outward by camming of the beveled surfaces 182 and 192 against the inner surface of the upper portion 120 and lower portion 130, respectively. The cylindrical portions 184 and 194 provide reinforcement. Moreover, when the upper expander member 180 and lower expander member 190 have been fully moved, the detents 185 and 195 engage the corresponding recesses 118 in the implant body 111, thereby locking the implant 100 in a fully expanded configuration and preventing the loosening of the implant.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. An implant comprising:
a body having a longitudinal axis, said body having at least one expandable portion configured to move between an unexpanded configuration and an expanded configuration; and
at least one linearly and non-rotatably movable expander member configured to contact said at least one expandable portion such that linear movement of said at least one expander member moves the at least one expandable portion between the unexpanded configuration and the expanded configuration.

2. The implant of claim 1, wherein the at least one expandable portion comprises an upper expandable portion and a lower expandable portion, and the at least one expander member comprises an upper expander member and a lower expander member wherein the upper expander member is in contact with the upper expandable portion and linear movement of the upper expander member effects movement of the upper expandable portion, and the lower expander member is in contact with the lower expandable portion and linear movement of the lower expander member effects movement of the lower expandable portion.

3. The implant of claim 2, wherein the body has a generally cylindrical shape.

4. The implant of claim 3, further comprising a rotatable rod axially extending through the implant and threadedly connected to the upper and lower expansion members, wherein the linear movement of the expander members is responsive to rotation of the rod.

5. The implant of claim 2, wherein the upper and lower expandable portions each include a plurality of longitudinal slots and the upper and lower expander members includes a peripheral beveled surface.

6. The implant of claim 5, wherein each of the upper and lower expander members includes a plurality of longitudinal ridges, each longitudinal ridge being slidably disposed within a respective longitudinal slot.

7. The implant of claim 6, wherein the peripheral beveled surface of the upper expander member is in camming contact with an upper circumferential edge and/or an interior surface of the upper expansion portion and the peripheral beveled surface of the lower expander member is in camming contact with a lower circumferential edge and/or interior surface of the lower expandable portion.

8. The implant of claim 7, wherein the upper and lower expander members each include a cylindrical portion having detents which are engageable with corresponding recesses in the implant body when the upper expander member and the lower expander member are moved from an initial position wherein the implant is not expanded to a final position wherein the implant is in a fully expanded configuration to lock the implant in the fully expanded configuration.

9. The implant of claim 1, wherein the body comprises gripping means disposed on an exterior surface of the body for increasing frictional contact with bone into which the implant is positioned.

10. The implant of claim 9, wherein the gripping means comprises at least one of the following: at least one circumferentially extending ridge having a horizontal radially extending upper surface and an angled lower surface, at least one circumferentially extending ridge having a horizontal radially extending upper surface and a horizontal radially extending lower surface, at least one circumferentially extending ridge having an angled upper surface and an angled lower surface, a textured surface, at least one radially outward extending conical spike, at least one radially outward extending block having a perimeter which is polygonal, circular or oval and at least one pyramidal projection.

11. The implant of claim 10, wherein the block further includes an outward facing textured surface.

12. The implant of claim 4, wherein the cylindrical body includes a radially inward projecting portion having a circular groove, and the rod includes a disk rotatably disposed within said circular groove.

13. The implant of claim 1, wherein said body is fabricated from a bio-compatible metal, synthetic polymer, ceramic or bone.

14. The implant of claim 2, further including an abutment member attached to the upper expander member and having a surface to which a prosthesis can be affixed.

15. A method for attaching an implant to a bone comprising:
a) providing an implant including:
a body having a longitudinal axis, at least one expandable portion configured to move between an unexpanded configuration and an expanded configuration; and
at least one linearly and non-rotatably movable expander member configured to contact said at least one expandable portions such that linear movement of said at least one expander member moves the at least one expandable portion between the unexpanded configuration and the expanded configuration.
b) drilling a hole in a bone;
c) inserting the implant into the hole in the bone while the implant is in the unexpanded configuration; and
d) moving the implant into the expanded configuration.

16. The method of claim 15, wherein the implant further includes a rotatable rod axially extending through the implant and threadedly connected to the at least one expander member, wherein the linear and non-rotational movement of the at least one expander member is responsive to rotation of the rod, and the step of moving the implant into the expanded configuration comprises rotating the rod to linearly move the at least one expander member.

17. The method of claim 15, wherein the step of moving the implant into the expanded configuration comprises moving the at least one expansion portion radially outward.

18. The method of claim 15, wherein expansion of the implant is performed with force sufficient to compress the bone and radially expand the hole in the bone.

19. The method of claim 15, further comprising:
joining an abutment member to the implant, said abutment member having a mounting surface to which the prosthesis can be mounted; and,
fixedly attaching the prosthesis to the mounting surface of the abutment member.

20. The method of claim 19, wherein the prosthesis is adhesively attached to the abutment member with a durable cement and the abutment member is adhesively fixed to the implant.
